(19) United States
(12) Patent Application Publication
(10) Pub. No.: US 2002/0170756 A1
(43) Pub. Date: Nov. 21, 2002

(54) Electric/gasoline driven vehicle

(76) Inventor: Maheshkumar M. Mehta, Rockingham, NC (US)

Correspondence Address: Charles Y. Lackey, Post Office Box 5871, Winston-Salem, NC, 27113-5871, US

(21) Appl. No.: 09/860,003

(22) Filed: May 18, 2001

(51) Int. Cl. B60K 1/00; B60K 6/00

(52) U.S. Cl. 180/65.2; 180/68.5

(57) ABSTRACT

An electric motor powered vehicle having at least one electric motor to supply power to the wheels of the vehicle, the improvement comprising a system associated with each of the at least one electric motors to supply power thereto including batteries arranged in series, a power generating means with windmill adapted to supply power to batteries preferably used in conjunction with a conventional gasoline powered engine.

### BACKGROUND OF THE INVENTION

1. Field of the Invention

The present invention relates to a vehicle that may be driven by a combination of electric and gasoline powered engines, and, more particularly, to an automobile in which electric motors are powered by batteries and the batteries are charged by the action of a windmill driven by air current experienced when the vehicle is moving.

2. Description of the Prior Art

Air pollution problems and fuel costs have been a significant factor in recent efforts to stimulate the development of a fuel efficient and low pollution power source for driving motor vehicles. While strides have been made to accomplish this objective, certain problems still exist and need to be overcome.

Electric cars have been known for quite some time and include small battery-operated vehicles such as golf carts which need to be re-charged almost after every use. Attempts to provide electric power for larger vehicles has not been successful since a considerable number of batteries is necessary in order to provide sufficient power to propel the automobile. Moreover, there is no reliable and efficient way of recharging such an enormous supply of batteries in a expeditious manner.

Thus there is still a great desire because of pollution and fuel prices to develop an efficient vehicle of this nature, and it is to this critical objective that the present invention is directed.

### OBJECTIVES AND BRIEF SUMMARY OF THE INVENTION

A principal objective of the present invention is to provide a combination electric/gasoline motor powered vehicle which includes all of the advantages of prior art devices and none of the disadvantages.

Another objective of the present invention is to provide a combination of an electric/gasoline powered vehicle which will reduce the polluting fumes associated with the exhaust discharging gasoline engines.

Yet another objective of the present invention is to provide the combination engine in which one or more electric motors are utilized to drive the vehicle by a plurality of batteries wired in series with the batteries being charged with the use of an alternator or generator associated with a windmill mounted on the vehicle.

Yet still another further objective of the present invention is to provide a combination motor of the type described which incorporates a self-charging arrangement to keep the batteries powering the electric motors in a fully operable condition.

From these objectives, it can be seen that the present invention is for a combination electric/gasoline engine, the electric motor being driven by a plurality of batteries connected in series that are placed in the vehicle and the gasoline driven engine being of a conventional nature except for a much smaller size that can be used to assist in propelling the vehicle. A windmill like device is positioned within the structure of the automobile and in a location where airflow engages it directly as the vehicle moves that is thereafter connected to a generator or alternator which provides electric power to charge the batteries on a continuous basis so long as the automobile is in motion. Separate controls are provided for each of the engines, and either of the motors can be disengaged and shut off selectively. The windmill device is preferably position near the radiator of the vehicle, and the plurality of batteries can be positioned under the rear seats or behind the cabin if the vehicle is a lightweight truck. The windmill can function to cool the radiator as well as maintain the electric power source for charging the batteries.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a perspective view showing the exterior of a conventional vehicle that might utilize the present invention;

FIG. 2 is a cross-sectional view of a motor vehicle showing the electric motor operating arrangement isolated from the internal combustion engine;

FIG. 3 is a plan and schematic view of the axle arrangement and the application of the electric motor through battery power and the gasoline engine with a connecting transmission for propelled vehicle; and

FIG. 4 is a schematic view of a circuit employed and operating the electric motors of the present invention.

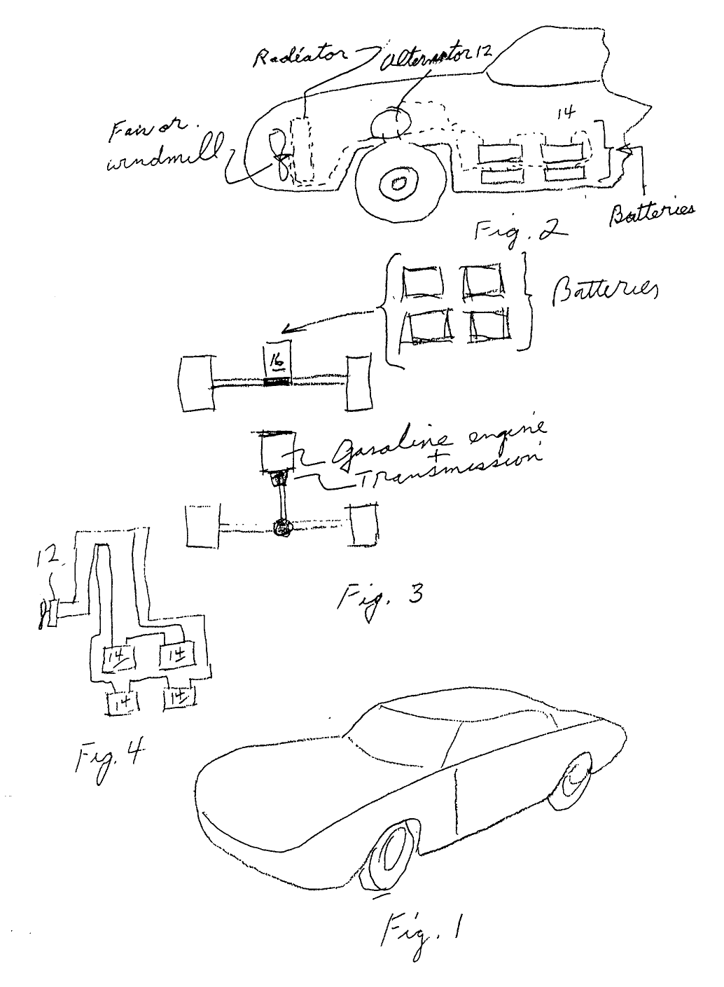

### DETAILED DESCRIPTION OF THE PREFERRED EMBODIMENT

The present invention is for a combination electric/gasoline driven motor that can be used together to drive a motor vehicle under normal operating conditions. The electric portion of the combination motor is best illustrated in FIG. 2 wherein a fan or windmill device is mounted near the radiator of the vehicle to efficiently receive air flow as the vehicle moves and also to provide some cooling effect for the radiator. The fan turns and alternator 12 or some other generating device is utilized to provide electric power to charge batteries 14 connected in series and positioned in some location in the automobile that will not cause passenger discomfort such as under the seats or behind the cab should the vehicle be a small truck. As the vehicle moves forward, air flow turns the fan or windmill device, and a directly driven alternator is secured to it so that electric power flows to batteries 4 and hereafter to motor 16 to assist with the propulsion of the vehicle.

The diagram for the electric system of the present invention is shown in FIG. 4 wherein batteries 14 are connected in series with each other and with alternator 12. Motor 16 (FIG. 3) is driven directly from batteries 14.

The gasoline portion of the present invention is of a conventional nature except that the motor is a smaller motor than normally used in an automobile internal combustion engine. Somewhere between a 30 to 50 horsepower engine should provide sufficient power to the wheels of the vehicle and move it forward as well as keep the polluting fumes to a minimum. One combination of the present invention is illustrated schematically in FIG. 3 wherein the electric motor is directly connected to one axle while the gasoline is connected to the second axle. Obvious combinations of this arrangement are available with both motors disbursing power to both axles.

Separate controls are provided for each engine so that one or both can be utilized selectively.

While the electric motor can be utilized solely to propel the vehicle, it may be necessary to employ the combination of both engines when higher speeds are desired.

More than one electric motor can be utilized to furnish power for one or both axles, and it is possible that a separate electric motor could be applied to each wheel in a conventional manner to give even more power for propulsion.

Thus it can be seen that a combination electric/gasoline powered engine has been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. In an electric motor-driven vehicle wherein the vehicle is provided with at least one electric motor to supply power for the wheels of the vehicle wherein the improvement comprises: a system associated with the at least one electric motor to supply electric power thereto having batteries charged by electric power generating means, a windmill element attached thereto; airflow directing means formed in the body of the vehicle, the airflow directing means and windmill wheel element being so aligned that air through the airflow directing means impinges upon the windmill element to rotate the element and operate the power generating means; a separate control for each of the at least one or more electric motors; and means for shutting off the airflow directing means.

2. The electric motor-driven vehicle as claimed in claim 1 wherein the vehicle further contains a conventional gasoline powered engine for auxiliary power which engine is connected by drive shaft means to one or more wheels of the vehicle.

3. In an electric motor driven vehicle wherein the vehicle is provided with at least one electric motor to supply power for the vehicle wherein the improvement comprises: an individual system associated with the at least one electric motor to supply electric power thereto including batteries arranged in series, the batteries charged by electric energy supplied by the windmill element and by the electric power generating means, the windmill element and electric power generating means being so aligned that air impinges upon the windmill element to rotate the element and operate the electric power generating means, and wherein the at least one motor of the vehicle further has a motor control for independently operating the at least one electric motor.

4. The electric motor driven vehicle of claim 3 wherein the vehicle further contains a conventional gasoline driven engine for auxiliary power which engine is connected by drive shaft means to the at least one electric motor of the vehicle.

5. In an electric motor driven vehicle wherein the vehicle is provided with at least one electric motor to supply power for the vehicle wherein the improvement comprises: an individual system associated with the at least one electric motor to supply electric power thereto including batteries arranged in series, the batteries charged by electric energy supplied by one or more sources including an alternator or a generator selectively adapted to be arranged in series with the battery and with each other and placed in the body of the vehicle wherein the at least one electric motor is provided with a separate control for independent operation.

6. The electric motor-driven vehicle of claim 5 wherein the vehicle further contains a conventional gasoline powered engine for auxiliary power which engine is connected by drive shaft means to at least one wheel of the vehicle.
